(19) United States
(12) Patent Application Publication
(10) Pub. No.: US 2022/0373256 A1
(43) Pub. Date: Nov. 24, 2022

(54) DISTILLATION COLUMN CHAMBER AND METHOD FOR TRANSPORTING A DISTILLATION COLUMN

(71) Applicant: L'Air Liquide, Societe Anonyme pour l'Etude et l?Exploitation des Procedes Georges Claude, Paris (FR)

(72) Inventors: Remy KURTZ, Champigny Sur Marne (FR); Arnaud FAVRE, Champigny Sur Marne (FR)

(73) Assignee: L'Air Liquide, Societe Anonyme pour l'Etude et l?Exploitation des Procedes Georges Claude, Paris (FR)

(21) Appl. No.: 17/742,024

(22) Filed: May 11, 2022

(30) Foreign Application Priority Data
May 19, 2021 (FR) FR 2105206

(51) Int. Cl. F25J 3/04

(52) U.S. Cl. CPC F25J 3/04945; F25J 3/04896; F25J 2290/30

(57) ABSTRACT

A distillation column is constituted by a cylindrical shell which contains mass and heat transfer elements and which is closed at one end by a cap and at the other end by a domed bottom and a cylindrical skirt that has the same diameter as the cylindrical shell, is aligned coaxially with the cylindrical shell and is fixed to one end of the cylindrical shell so as to surround the domed bottom, forming a space between the bottom, the walls of the skirt and a base, the skirt comprising at least one opening to allow the passage of a flushing gas.

### CROSS REFERENCE TO RELATED APPLICATIONS

This application claims the benefit of priority under 35 U.S.C. § 119 (a) and (b) to French patent application No. FR2105206, filed May 12, 2021, the entire contents of which are incorporated herein by reference.

### FIELD OF THE INVENTION

The present invention relates to a distillation column chamber and to a method for transporting a distillation column.

### BACKGROUND OF THE INVENTION

Distillation columns operating at temperatures below 0° C. must be thermally insulated so as to reduce heat losses. In general, they are disposed in a parallelepipedal or cylindrical chamber filled with thermal insulation. A distillation column is constituted by a cylindrical shell which contains mass and heat transfer elements, for example structured packings or distillation plates.

As the insulation with which the chamber must be filled has a certain weight and must be kept dry, it is generally poured into the chamber once the column has been installed at its final site at which it must operate to distil a mixture of gases.

For relatively lightweight columns, a structure below a column can hold it in place.

For heavier columns, another solution is necessary.

The column has a cylindrical overall shape with a domed bottom and is held vertical by a cylindrical element referred to as “skirt” in the case of the heaviest columns, for example those made of stainless steel. This skirt has the same diameter as the column and is aligned coaxially with the shell ring; it is fixed to the shell ring of the column. A closed and empty space is thus located directly below the column between the domed bottom and the flat surface on which the column is fixed.

This flat surface can be the base of the chamber or else another base corresponding to a plate disposed on the base of the chamber.

It is important that this closed and empty space is insulated so as to not leave spaces without insulation.

### SUMMARY OF THE INVENTION

Certain embodiments of the invention can provide at least one opening in the skirt to allow the flushing nitrogen to enter the space between the skirt and the domed bottom of the column and/or to allow pulverulent insulation to be introduced into the space between the skirt and the domed bottom of the column.

In the prior art, the flushing gas was released into the perlite around the column but was not introduced into this space, thereby posing severe safety problems in the event of fluid from the column leaking into the space.

U.S. Pat. No. 3,750,413 discloses a distillation column having a domed bottom and a cylindrical skirt, the skirt being passed through by a pipe connected to the interior of the column through the domed bottom so as to introduce a fluid therein or remove a fluid therefrom.

The flushing nitrogen circulates only outside the column and does not participate in the distillation.

According to a subject of the invention, what is provided is a parallelepipedal or cylindrical chamber containing a distillation column constituted by a cylindrical shell which contains mass and heat transfer elements and which is closed at one end by a cap and at the other end by a domed bottom (E) and a cylindrical skirt (J) that has the same diameter as the shell ring, is aligned coaxially with the shell ring and is fixed to one end of the shell ring so as to surround the domed bottom, forming a space (I) between the bottom, the walls of the skirt and a base and comprising means for releasing a flushing gas inside the chamber but outside of the space, characterized in that the skirt comprises at least one opening, preferably at least two openings, to allow the flushing gas to circulate in the space (I), the space being filled with pulverulent thermal insulation.

Preferably:
the skirt comprises means for closing the at least one opening.
the space is filled with perlite.
the space does not contain any packings or plates.
at least two openings in the shell ring face one another.
the chamber contains pulverulent thermal insulation solely in the space.
the chamber contains pulverulent thermal insulation in a space between the chamber and the column.
the skirt comprises two openings, preferably facing one another, to allow the flushing gas to circulate through the space.

According to another subject of the invention, what is provided is a method for transporting a distillation column, in which:
i) at a first site, a distillation column constituted by a cylindrical shell which contains mass and heat transfer elements and which is closed at one end by a cap and at the other end by a domed bottom and a cylindrical skirt that has the same diameter as the shell ring, is aligned coaxially with the shell ring and is fixed to one end of the shell ring so as to surround the domed bottom, forming a space between the bottom, the walls of the skirt and a base, the skirt comprising at least one opening (O1, O2), preferably at least two openings, which is/are able to allow a flushing gas to circulate in the space, is assembled by disposing the insulation in the space,
ii) the column is transported to a second site possibly inside a parallelepipedal or cylindrical chamber,
iii) once it has arrived at the second site, the column is positioned with its axis vertical and is placed in a chamber, if it is not transported in the chamber, and a space in the chamber around the column is filled with pulverulent thermal insulation at the second site.

According to other, optional aspects:
the means for closing the at least one opening are closed at the first site and, once the column has arrived at the second site, the means for closing at least one opening are opened or removed such that at least one opening is open.
at least one zone inside the chamber (CB) is insulated with rock wool.
the space does not contain any liquid during use.
a duct does not pass through the at least one opening.
the at least one opening is dimensioned so as to allow pulverulent thermal insulation to be introduced into the space.

In this way, the complex operation of insulating the space below the shell ring is carried out at a site at which, for example, more experienced workers are present and the loose filling is carried out at a different site, at which less qualified workers are present.

Preferably, the means for closing the at least one opening are closed at the first site and, once the column has arrived at the second site, the means for closing at least one opening are opened or removed such that at least one opening is open.

At least one zone inside the chamber may be insulated with rock wool.

According to another subject of the invention, what is provided is a method for filling a chamber with pulverulent insulation, the chamber containing a distillation column constituted by a cylindrical shell which contains mass and heat transfer elements and which is closed at one end by a cap and at the other end by a domed bottom and a cylindrical skirt that has the same diameter as the shell ring, is aligned coaxially with the shell ring and is fixed to one end of the shell ring so as to surround the domed bottom, forming a space between the bottom, the walls of the skirt and a base, the skirt comprising at least one opening, preferably at least two openings, in which method the pulverulent insulation is poured into the chamber through an opening in the chamber and enters the space through at least one opening.

### BRIEF DESCRIPTION OF THE DRAWINGS

Further features and advantages of the invention will become apparent from the description hereinafter of embodiments, which are given by way of illustration but without any limitation, the description being given in relation with the following attached figures:

FIG. 1 shows a column according to the invention.

FIG. 2 shows the column from FIG. 1 disposed inside a chamber.

### DETAILED DESCRIPTION OF THE INVENTION

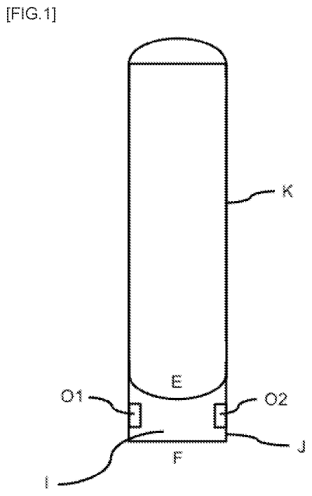

FIG. 1 shows a distillation column constituted by a cylindrical shell K which contains mass and heat transfer elements, for example structured packings or distillation plates. The column is closed at one end by a cap and at the other end by a domed bottom E. A cylindrical skirt J that has the same diameter as the shell ring K and is aligned coaxially with the shell ring is fixed to one end of the column so as to surround the domed bottom E, forming a space I between the bottom, the walls of the skirt and the base F. The skirt J is fixed to the flat base in a sealed manner, for example by welding it in place. Otherwise, an annular flange around the skirt J may be fixed to the base, as described in FR2775438.

At least one opening, preferably at least two openings O1, O2, are made in the skirt J and can be closed by using closing means, such as a plug, comprising an insulation layer, such as rock wool. These openings are not taken up by the passage of a duct or another element, such that the pulverulent insulation can be introduced into the space. The openings also allow a flushing gas, circulating outside the column and the skirt, to enter the space I below the domed bottom E.

The space I formed is filled with pulverulent thermal insulation, for example perlite. Preferably, the insulation is introduced into the space by being sent through at least one of the openings O1, O2. The space I contains neither packings nor plates. It may contain at least one duct and/or at least one valve, for example.

Since the skirt J is fixed in a sealed manner to the base and the openings O1, O2 are properly closed, the insulation remains in the space.

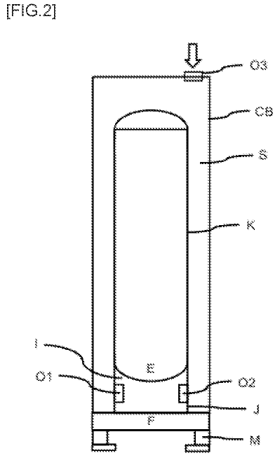

FIG. 2 illustrates that, in order to be used as a distillation column at a temperature less than 0° C., the column must be disposed in a parallelepipedal or cylindrical closed chamber CB filled with thermal insulation, for example pulverulent thermal insulation.

According to the invention, in a first step, only the space between the skirt J and the bottom E of the column is filled with insulation and this filling preferably takes place in the assembly and/or manufacturing workshop. Then, the column can be transported inside the chamber CB or else disposed in the chamber CB once it has arrived at the final site at which it must operate. Thus, if the column is transported in the chamber CB, it does not contain any insulation except for that installed between the skirt J and the domed bottom E of the column. In this case, the space S between the shell ring K, the skirt J and the chamber surrounding them therefore contains air and is not filled with insulation.

Once the column has arrived on site and, if appropriate, disposed in the chamber CB, the means for closing at least one opening O1, O2 are removed and the chamber is filled with pulverulent thermal insulation, given that at least one zone inside the chamber CB may also contain rock wool as insulation.

This filling is done by pouring the pulverulent insulation through an opening O3, for example in the roof of the chamber CB.

When the column is in operation, the interior of the chamber CB is permanently flushed by dry nitrogen, thus making it possible to evacuate leaks towards the roof of the chamber CB in a known manner. Having at least one opening O1, O2 in the skirt J of the column open makes it possible for this flushing gas to enter the space I and to flush the insulation it contains. This makes it possible to evacuate water which could be present in the space I if the insulation was moist. If the water freezes, this could weaken the skirt J and/or the bottom E. Of course, the use of at least two openings O1, O2 makes it possible to better circulate flushing gas inside the skirt J. If two of the openings O1, O2 face one another, this promotes good circulation.

The presence of at least one opening makes it possible to introduce pulverulent insulation inside the skirt so as to completely or partially fill the space. The insulation could settle during travel, for example, such that spaces are created below the bottom.

Prefilling the interior of the skirt with thermal insulation makes it possible to better distribute the insulation usually introduced via the roof of the chamber, once the column has arrived on site. Specifically, it is difficult to ensure good distribution of insulation in the space I below the domed bottom E, in particular in the junction zones between the skirt J and the domed bottom E.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

We claim:

1. A chamber selected from the group consisting of a parallelepipedal chamber and a cylindrical chamber, the chamber comprising:
a distillation column constituted by a cylindrical shell which contains mass and heat transfer elements and which is closed at one end by a cap and at the other end by a domed bottom;
a cylindrical skirt that has the same diameter as the cylindrical shell, wherein the cylindrical skirt is aligned coaxially with the cylindrical shell and is fixed to a bottom portion of the cylindrical shell so as to surround the domed bottom, forming a space between the domed bottom, the walls of the skirt, and a base; and
means for releasing a flushing gas inside the chamber but outside the space,
wherein the skirt comprises at least one opening that is configured to allow the flushing gas to circulate in the space, the space being filled with pulverulent thermal insulation.

2. The chamber according to claim 1, wherein the skirt comprises means for closing the at least one opening.

3. The chamber according to claim 1, wherein the space is filled with perlite.

4. The chamber according to claim 1, wherein the space does not contain any packings or plates.

5. The chamber according to claim 1, wherein at least two openings in the cylindrical shell face one another.

6. The chamber according to claim 1, wherein the pulverulent thermal insulation is solely in the space.

7. The chamber according to claim 1, containing pulverulent thermal insulation in a space between the chamber and the column.

8. The chamber according to claim 1, wherein the skirt comprises two openings, one facing the other, to allow the flushing gas to circulate through the space.

9. A method for transporting a distillation column, the method comprising the steps of:
i) at a first site:
providing a distillation column constituted by a cylindrical shell which contains mass and heat transfer elements and which is closed at one end by a cap and at the other end by a domed bottom,
coaxially aligning the distillation column with a cylindrical skirt that has the same diameter as the cylindrical shell,
affixing the cylindrical skirt to a bottom portion of the cylindrical shell so as to surround the domed bottom, thereby forming a space between the domed bottom, the walls of the skirt and a base, the skirt comprising at least one opening, which is configured to allow a flushing gas to circulate in the space, and
introducing thermal insulation in the space;
ii) transporting the column to a second site by itself or inside a chamber selected from the group consisting of parallelepipedal and cylindrical,
iii) after arrival at the second site, positioning the distillation column with its axis vertical and is placed in a chamber, if the distillation column is not transported in the chamber, and a second space in the chamber around the column is filled with pulverulent thermal insulation at the second site.

10. The method according to claim 9, wherein the column is in accordance with claim 2 and the means for closing the at least one opening are closed at the first site and, once the distillation column has arrived at the second site, the means for closing at least one opening are opened or removed such that at least one opening is open.

11. The method according to claim 9, wherein at least one zone inside the chamber is insulated with rock wool.
